(19) United States
(12) Patent Application Publication
(10) Pub. No.: US 2022/0061513 A1
(43) Pub. Date: Mar. 3, 2022

(54) VERSATILE REFILL HEADS FOR MANUAL AND ELECTRIC TOOTHBRUSHES AND TOOTHBRUSH KIT USING SAME

(71) Applicant: The Procter & Gamble Company, Cincinnati, OH (US)

(72) Inventor: Uwe JUNGNICKEL, Königstein (DE)

(21) Appl. No.: 17/462,089

(22) Filed: Aug. 31, 2021

Related U.S. Application Data
(60) Provisional application No. 63/072,256, filed on Aug. 31, 2020.

(51) Int. Cl. A46B 5/00; A46B 9/04; A61C 17/22; A46B 15/00

(52) U.S. Cl. CPC A46B 5/0095; A46B 9/04; A46B 15/0085; A61C 17/225; A46B 15/0026; A61C 17/222

(57) ABSTRACT

A plurality of mass-produced versatile toothbrush refills for a secure removable engagement with a plurality of mass-produced non-identical toothbrush handles including handles of electric toothbrushes and handles of manual toothbrushes. Each of the refills comprises: a proximal and distal ends opposite thereto and a longitudinal axis extending between the proximal end and the distal end; a cleaning head with a plurality of cleaning elements adjacent to the distal end; and a neck extending from the cleaning head and terminating at the proximal end. The neck has a wall defining a cavity for receiving a handle engagement structure of any one of the toothbrush handles. The refill includes a refill engagement structure configured to form the secure removable engagement with the handle engagement structure.

### FIELD OF THE INVENTION

The present disclosure is concerned with versatile refill heads for a plurality of toothbrushes, and toothbrush systems and kits including such, wherein the refill heads are structured and configured to be repeatedly attached to and detached from a plurality of various toothbrush handles including manual toothbrush handles and electric toothbrush handles.

### BACKGROUND OF THE INVENTION

Heads and handles for oral-care implements, such as manual toothbrushes and electric (aka power) toothbrushes are well known in the art. A manual toothbrush is a conventional toothbrush that relies on a user's manual movement during a brushing cycle and includes neither a power source nor a motor. An electric toothbrush is a toothbrush that includes a motor, for vibrating or otherwise moving the toothbrush's cleaning elements, and most typically a power source, such as, e.g., a secondary (rechargeable) electric battery or a primary (non-rechargeable) battery, to supply power to the motor.

Both types of toothbrushes, manual and electric, include a portion, commonly referred to as a brush head, comprising a bristle carrier having a plurality of cleaning elements, such as, e.g., tufts or bristles—or other implements, such as, e.g., resinous cleaning elements—for cleaning teeth and, in some cases, soft tissue in the mouth. Those include, e.g., various interdental tools, tongue-cleaning tools, and oral-care substance applicators.

A head of a conventional manual toothbrush is permanently connected to the handle via an element commonly referred to as a neck, which is disposed between the toothbrush handle and the toothbrush head. This permanent connection is typically done by injection molding, which results in a production of a unitary toothbrush structure wherein the head, the handle, and the neck form a single integral item, which cannot be separated into discrete elements without violating the structural integrity of the toothbrush, and hence rendering it practically unusable.

Dentists recommend that an average person replace a toothbrush every three to four months. Some particularly health-conscious consumers may wish to replace their oral-care tools even more frequently. Thus, a conventional manual toothbrush, comprising a single unitary item, should be discarded after approximately three months of use, if not more frequently. So should an average refill head of an electric toothbrush. But if replacing a refill head on an electric toothbrush involves discarding only a small (and the least expensive) part of the overall brush while preserving its most essential (and most expensive) part, handle, replacing a manual toothbrush inevitably requires discarding the entire brush, including its handle. As used herein, the terms “refill head” and “refill” are synonymous—and used herein interchangeably.

Environmental concerns and related efforts to provide ecologically friendly and sustainable manual toothbrushes, generating less waste, particularly less plastic waste, have led to designs of manual toothbrushes comprising replaceable refill heads, i.e., refills that can be attached to and detached from a handle, whereby an old, worn-out refill head can be replaced with a fresh one. Such brushes allow a consumer, instead of purchasing a new toothbrush and later discarding it, purchase only a new refill to replace the old one, while keeping and reusing the handle. Disposable brush refills are usually less expensive and generate significantly less waste than conventional manual toothbrushes do. Following such an approach, manufacturers try to design high-quality and more aesthetically pleasing—and consequently relatively more expensive—handles for manual toothbrushes, which handles could be used over a much longer period of time as compared to those of common manual toothbrushes. Thus, relatively inexpensive brush refills can be routinely and economically replaced on a regular basis on both manual toothbrushes and electric toothbrushes. This could provide a cost-efficient and environmentally sustainable superior toothbrushes having improved handling properties and aesthetics.

This could also assist consumers in managing their individual oral-care routines. Some consumers practice their oral hygiene by using both manual and electric toothbrushes. Such varied use could be alternating or serial—and can be based on the user's convenience, circumstances, occasional necessity, and other considerations. For example, people who prefer to travel “light” may want to avoid carrying in their luggage an electric toothbrush, which is typically significantly bulkier and heavier than a manual toothbrush, especially if an electric toothbrush requires frequent recharging, which would also require packing and carrying along a recharger. Besides, some air-travel regulations pertaining to transportation of batteries and battery-containing products could be perceived by some consumers as a potential unnecessary complication, which could be easily avoided by traveling with a manual toothbrush (having no battery) instead of an electric one (including a battery).

Further, using both an electric toothbrush and a manual toothbrush may be a matter of convenience and/or economy, especially in a common family setting where there is a single electric toothbrush handle, used by several family members, each using a personal refill head attachable to the same handle. In instances where two or more family members desire to brush teeth at the same time, a first family member can use an electric handle, while a second family member can simultaneously use a manual handle. (Next time, the roles could be reversed.) The ability of all family members to use their own personal refill heads on both the electric toothbrush handle and the manual toothbrush handle would allow the users additional benefits in convenience of maintaining their oral care, while effectively addressing environmental and waste-reduction concerns.

The present disclosure provides versatile refills for both manual and electric toothbrushes. As used herein, the terms “toothbrush refill” or simply “refill” are used to refer to oral-care replaceable portions structured and configured to be attached to and detached from an oral-care implement's handle—and include those having tufted bristles as well as those having resinous/elastomeric cleaning elements, or cleaning elements made of any other suitable material. These refills can be designed for brushing teeth, interdental cleaning, soft-tissue cleaning (e.g., tongue cleaning), application of chemical substances for the oral-care purposes, or for any other oral-care-related procedure intended for being used by an individual consumer. All of these refills are included in the scope of the present disclosure.

The present disclosure also provides a plurality of mass-produced identical toothbrush refills for a removable engagement with a plurality of mass-produced non-identical toothbrush handles. The present disclosure further provides a toothbrush system, comprising at least one electric toothbrush handle, at least one manual toothbrush handle, and at least one toothbrush refill for removable engageable with each of the electric toothbrush handle and the manual toothbrush handle. The present invention also provides a toothbrush system comprising at least a first manual toothbrush handle made of a first polymer and a second manual toothbrush handle made of a second polymer different from the second polymer, and at least one toothbrush refill for removable engagement with each of the first and second handles. Lastly, the present disclosure provides an oral-care kit comprising at least a first manual toothbrush handle, a second manual toothbrush handle different from the first manual toothbrush handle, at least one electric toothbrush handle, and at least one charger for charging the electric toothbrush.

### SUMMARY OF THE INVENTION

In its first aspect, the present disclosure is directed to a plurality of mass-produced identical toothbrush refills for a removable engagement with a plurality of mass-produced non-identical toothbrush handles, each of the plurality of mass-produced identical refills comprising: a proximal end and a distal end opposite thereto and a longitudinal axis extending between the proximal end and the distal end; a cleaning head disposed adjacent to the distal end and comprising a plurality of cleaning elements; a neck extending from the cleaning head and terminating at the proximal end, the neck comprising a wall defining a cavity configured to receive a handle engagement extension, including a handle engagement structure, of any one of the plurality of mass-produced non-identical toothbrush handles for the removable engagement therewith; wherein each of the plurality of mass-produced identical refills includes a refill engagement structure configured to form a secure removable engagement with the handle engagement structure; and wherein each of the plurality of mass-produced identical refills is structured and configured to removably engage each of the plurality of mass-produced non-identical toothbrush handles including handles of electric toothbrushes, which include a power source, and handles of manual toothbrushes, which do not include a power source.

In its second aspect, the present disclosure is directed to a versatile toothbrush refill having a proximal end, a distal end opposite to the proximal end, and a longitudinal axis extending between the proximal and distal ends, the refill comprising: a head adjacent to the distal end and including cleaning elements; a neck extending from the head along the longitudinal axis and terminating at the proximal end, the neck comprising a wall defining a cavity configured to receive therein a handle engagement extension, the handle engagement extension comprising a handle engagement structure; wherein the wall comprises a refill engagement structure for engaging the handle engagement structure; and wherein the refill engagement structure is configured to be compatible for a removable engagement with each of a first toothbrush handle that includes a power source and a second toothbrush handle that does not include a power source.

In its third aspect, the present disclosure is directed to a versatile toothbrush refill having a proximal end, a distal end opposite to the proximal end, and a longitudinal axis extending between the proximal and distal ends, the refill comprising: a head adjacent to the distal end and including cleaning elements; a neck extending from the head along the longitudinal axis and terminating at the proximal end, the neck comprising a wall defining a cavity configured to receive therein a handle engagement extension comprising a handle engagement structure; wherein the wall comprises a refill engagement structure for engaging the handle engagement structure; and wherein the refill engagement structure is configured for a removable engagement with each of a first handle engagement structure of a manual toothbrush handle that includes a power source and a second handle engagement structure of an electric toothbrush handle that does not include a power source; and wherein the refill includes indicia indicating that the refill can be used with a compatible manual toothbrush handle and a compatible electric toothbrush handle.

In its fourth aspect, the present disclosure is directed to a versatile toothbrush refill comprising a head comprising cleaning elements; a neck extending from the head and comprising a wall defining a cavity; wherein the neck includes indicia indicating that the refill is compatible for use with each of a manual toothbrush handle, which lacks a power source, and an electric toothbrush handle, which includes a power source; wherein the cavity is configured for removeable engagement with a first handle engagement extension of the manual toothbrush handle and a second handle engagement extension of the electric toothbrush handle; and wherein the wall of the neck comprises a universal refill engagement structure that is configured for removable engagement with each of a handle engagement structure of the first handle engagement extension and a handle engagement structure of the second handle engagement extension.

In its fifth aspect, the present disclosure is directed to a versatile toothbrush refill having a proximal end, a distal end opposite to the proximal end, and a longitudinal axis extending between the proximal and distal ends, the refill comprising: a head adjacent to the distal end and including cleaning elements; a neck extending from the head along the longitudinal axis and terminating at the proximal end, the neck comprising a wall defining a cavity configured to receive therein a handle engagement extension comprising a handle engagement structure; wherein the wall comprises a refill engagement structure for engaging the handle engagement structure; and wherein the refill engagement structure is configured for a removable engagement with each of a first handle engagement structure of a first manual toothbrush handle and a second handle engagement structure of a second manual toothbrush handle, wherein the first manual toothbrush handle differs from the second manual toothbrush handle in at least one physical characteristic selected from the group consisting of a shape of the handle and at least one material property other than color.

In its sixth aspect, the present disclosure is directed to a toothbrush system comprising: at least one electric toothbrush handle comprising a power source; at least one manual toothbrush handle lacking a power source; and at least one versatile toothbrush refill structured and configured to be removably engageable with each of the electric toothbrush handle and the manual toothbrush handle. The at least one manual toothbrush handle may comprise a first manual toothbrush handle and a second manual toothbrush handle, wherein the first manual toothbrush handle and the second manual toothbrush handle differ from one another in at least one characteristic selected from the group consisting of polymer resin, color, density, surface texture, translucency, weight, magnetic qualities, and any combination thereof.

In its seventh aspect, the present disclosure is directed to a toothbrush system comprising: at least a first manual toothbrush handle and a second manual toothbrush handle, the first manual toothbrush handle comprising a first polymer, and a second manual toothbrush handle comprising a second polymer, the first polymer being different from the second polymer; and at least one versatile toothbrush refill structured and configured to be removably engageable with each of the first manual toothbrush handle and the second manual toothbrush handle. The first polymer may different from the second polymer in at least one characteristic selected from the group consisting of polymer resin, density, surface texture, translucency, weight, magnetic qualities, and any combination thereof.

In its eighth aspect, the present disclosure is directed to an oral-care kit comprising at least a first manual toothbrush handle, a second manual toothbrush handle, and at least one electric toothbrush handle. The first manual toothbrush handle differs from the second manual toothbrush handle in at least one characteristic selected from the handle's shape, color, density, surface texture, translucency, weight, magnetic qualities, and any combination thereof. The kit further includes at least one electric charger for charging the at least one electric toothbrush handle. The kit also includes a plurality of versatile toothbrush refills, wherein each of the refills is structured and configured to be removably engageable with each of the first manual toothbrush handle, the second manual toothbrush handle, and the electric toothbrush handle, for a secure connection therewith.

In one example embodiment, the refill engagement structure comprises at least one recess disposed in the wall of the neck and configured to receive at least a portion of the handle engagement structure comprising a spring-loaded ball, biased in a direction substantially perpendicular to the longitudinal axis of the refill. The ball can be partially disposed inside a body of the handle engagement extension, wherein an exposed portion of the ball that extends therefrom has a height that is less than a radius of the ball, the height being measured from an outer surface of the handle engagement extension surrounding the ball. In a further example embodiment, the exposed portion of the ball has a height selected from the group consisting of a height of from 20% to 50% of the ball's diameter, a height of from 25% to 45% of the ball's diameter, a height of from 30% to 40% of the ball's diameter, and a height of 35% of the ball's diameter. The refill engagement structure can further comprise a groove disposed on an interior surface of the wall of the neck and configured to facilitate the secure removable engagement between the refill and the toothbrush handle.

The proximal end of the neck can beneficially comprise an end perimeter disposed in a plane that is non-perpendicular relative to the longitudinal axis of the refill, so that an angle formed between the plane in which the end perimeter is disposed and the longitudinal axis of the refill is selected from the group consisting of an angle of from 30 degrees to 80 degrees, an angle from 45 degrees to 75 degrees, an angle from 60 degrees to 70 degrees, and an angle of 65 degrees.

In one embodiment, each of the refills includes indicia indicating that the refill can be used with a compatible manual toothbrush handle and a compatible electric toothbrush handle. The indicia can include a brand name. The brand name of the refill can be different from a brand name of the manual toothbrush handle and/or a brand name of the electric toothbrush handle.

Either the refill or the handle, or both, may be made from a material having magnetic and/or ferromagnetic properties. Magnetic/ferromagnetic material possesses a relatively high density—and thus a relatively heavy weight of the handle, which could be beneficial in terms of providing a user with a comfortable feeling during use of the toothbrush and an overall perception of a high-quality product. In one embodiment, at least one of the handle engagement structure and the refill engagement structure comprises a magnetic and/or ferromagnetic material. This can magnetically facilitate the process of connecting the refill to the handle, and also securely holding those together during the brushing cycle. In addition, the handle comprising a magnetic and/or ferromagnetic material, could be structured and configured to be magnetically attached to a magnetic holder, such as, e.g., a wall holder, which would provide hygienic storage of the toothbrush—as remaining water, toothpaste slurry, and saliva would drain off from the brush while it is attached to the wall magnetic holder, thereby reducing bacteria growth on the brush.

These and other benefits provided by the present disclosure will be described in more detail herein below, in conjunction with several example embodiments and the accompanying drawings.

### BRIEF DESCRIPTION OF THE DRAWINGS

The invention is described in more detail below with reference to various embodiments and figures, schematically illustrating the invention, wherein:

FIG. 1 shows a perspective view of a plurality of mass-produced identical toothbrush refills for a removable engagement with a plurality of mass-produced non-identical toothbrush handles;

FIG. 2 shows a fragmental perspective view of an embodiment of a toothbrush comprising a refill, a handle, and a connector;

FIG. 3 shows a fragmental perspective view of the toothbrush handle having the connector shown in FIG. 2;

FIG. 4 shows a side view of the handle with connector shown in FIG. 3;

FIG. 5 shows a front view of the handle with the connector shown in FIG. 3;

FIG. 6 shows a top view of the handle with the connector shown in FIG. 3;

FIG. 7 shows a front view of an example embodiment of the connector according to the present disclosure;

FIG. 8 shows a side view of the connector of FIG. 7;

FIG. 9 shows a longitudinal cross-sectional view of the handle with the connector of FIG. 3;

FIG. 10 shows a cross-sectional view taken along line A-A of FIG. 9;

FIG. 11 shows a cross-sectional view taken along line B-B of FIG. 9;

FIG. 12 shows a perspective view of the refill shown in FIG. 1;

FIG. 13 shows a bottom view of the refill head of FIG. 12;

FIG. 14 shows a toothbrush system comprising at least two toothbrush handles that are made from different polymers;

FIG. 15 shows a toothbrush system comprising a plurality of refill heads and a plurality of handles that have indicia including indication of a brand name, and indicia indicating that the refill can be used with both manual and electric toothbrush;

FIG. 16 shows an oral-care kit comprising at least two different manual toothbrush handles, at least one electric toothbrush handle, a charger for charging the electric toothbrush handle, and a plurality of refill heads, wherein each of the refill heads can be used with each of the toothbrush handles;

FIG. 17 shows various replaceable oral-care refills, including brush-head refills, an interdental refills, a tongue-cleaner refill, and a chemistry-applicator refill;

FIG. 18 shows the various replaceable refills, shown in FIG. 17, attached to a toothbrush handle;

FIG. 19 shows embodiments of a wall holder with a toothbrush attached thereto, wherein the toothbrush is shown with various replaceable embodiments of refills; and

FIG. 20 shows embodiments of a wall holder with various refills disposed thereon.

### DETAILED DESCRIPTION OF THE INVENTION

The entire disclosures of the following commonly assigned patent applications are incorporated herein by reference:

Application Ser. No. 15/729,261, filed Oct. 10, 2017; U.S. Pat. No. 10,251,470 issued Apr. 9, 2019 (Atty Docket No. CM4503CQ);

Application Ser. No. 16/361,178, filed Mar. 21, 2019; Publication No. US 2019/0216212A1 published Jul. 18, 2019 (Atty. Docket No. CM4503CCQ);

Application Ser. No. 15/729,322, filed Oct. 10, 2017; Publication No. US 2019/0000223A1 published Jan. 3, 2019 (Atty Docket No. CM4515CQ);

Application Ser. No. 15/729,359, filed Oct. 10, 2017; Publication No. US 2019/0104834A1 published Apr. 11, 2019 (Atty Docket No. CM4529CQ);

Application Ser. No. 15/729,399, filed Oct. 10, 2017; Publication No. US 2019/0104835A1 published Apr. 11, 2019 (Atty Docket No. CM4535CQ);

Application Ser. No. 16/225,509, filed Dec. 19, 2018; Publication No. US 2019/0200748A1 published Jul. 4, 2019 (Atty Docket No. CM4892Q);

Application Ser. No. 16/225,592, filed Dec. 19, 2018; Publication No. US 2019/0200740A1 published Jul. 4, 2019 (Atty Docket No. CM4920Q);

Application Ser. No. 16/225,688, filed Dec. 19, 2018; Publication No. US 2019/0200742A1 published Jul. 4, 2019 (Atty Docket No. CM4928Q);

Application Ser. No. 16/225,809, filed Dec. 19, 2018; Publication No. US 2019/0200743A1 published Jul. 4, 2019 (Atty Docket No. CM4931Q);

Application Ser. No. 16/272,392, filed Feb. 11, 2019; Publication No. US 2019/0246779A1 published Aug. 15, 2019 (Atty Docket No. CM4944Q);

Application Ser. No. 16/272,422, filed Feb. 11, 2019; Publication No. US 2019/0246780A1 published Aug. 15, 2019 (Atty Docket No. CM4945Q);

Application Ser. No. 16/272,872, filed Feb. 11, 2019; Publication No. US 2019/0246781A1 published Aug. 15, 2019 (Atty Docket No. CM4949Q);

Application Ser. No. 16/272,943, filed Feb. 11, 2019; Publication No. US 2019/0248049A1 published Aug. 15, 2019 (Atty Docket No. CM4950Q);

Application Ser. No. 16/551,307, filed Aug. 26, 2019; Publication No. US 2020/0121069A1 published Apr. 23, 2020 (Atty Docket No. CM5015Q);

Application Ser. No. 15/715,095, filed Sep. 25, 2017; Publication No. US 2018/0087631A1 published Mar. 29, 2018 (Atty Docket No. CM4522Q);

Application Ser. No. 16/829,585, filed Mar. 25, 2020 (Atty Docket No. CM5072Q);

App. No. 19207432.6, filed Nov. 6, 2019 (Atty Docket No. CM5136FQ);

App. No. 20153084.7, filed Jan. 22, 2020 (Atty Docket No. CM5151FQ);

App. No. 20168691.2, filed Apr. 8, 2020 (Atty Docket No. CM5179FQ);

App. No. 20168731.6, filed Apr. 8, 2020 (Atty Docket No. CM5185FQ);

App. No. 20168692.0, filed Apr. 8, 2020 (Atty Docket No. CM5186FQ); and

App. No. 20177338.9, filed May 29, 2020 (Atty Docket No. CM5188FQ).

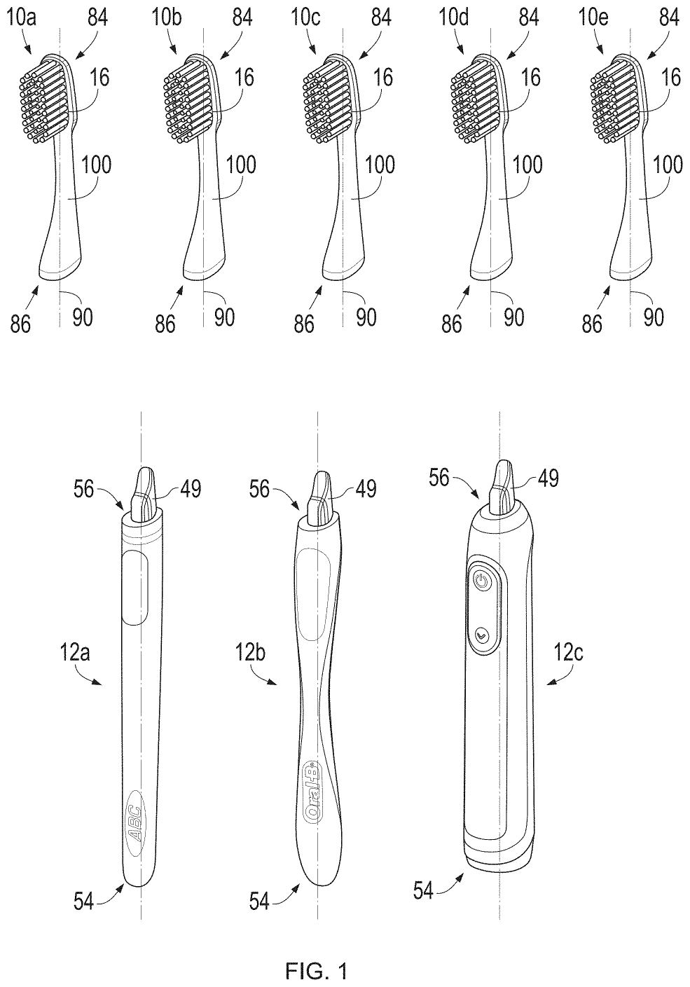

As is schematically shown in FIGS. 1, 2, 12, 14, and 15, each of the plurality of mass-produced identical toothbrush refills 10 (10a, 10b, 10c, 10d, 10e) has a distal end 84 and a proximal end 86 opposite to the distal end 84. A longitudinal axis 90 of the refill 10 extends between the distal end 84 and the proximal end 86. The refill 10 comprises a cleaning head 16, including a plurality of cleaning elements, disposed adjacent to the distal end 84. A neck 100 extends from the cleaning head 16 towards, and terminates at, the proximal end 86.

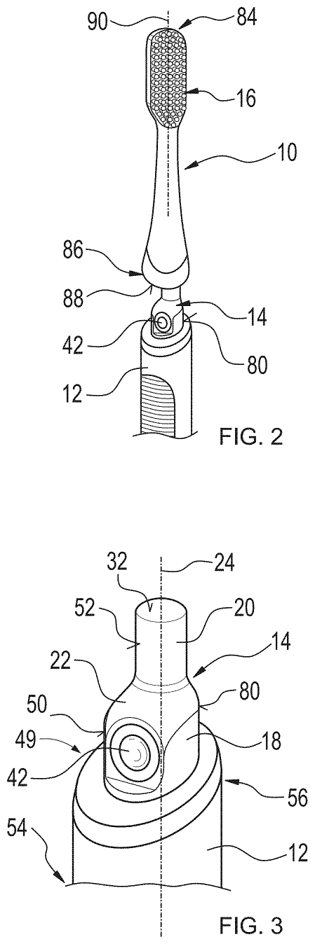

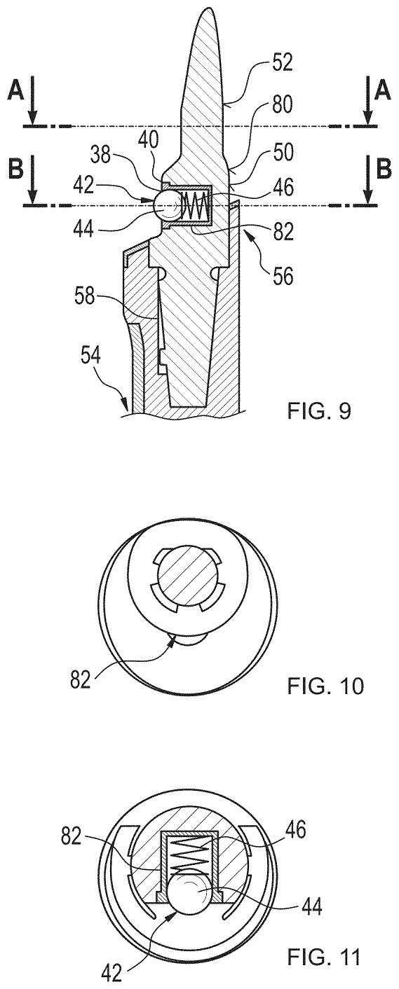

As is schematically shown in several Figures herein, the neck 100 of the refill 10 comprises a neck wall 68 that forms a hollow portion, or cavity, 66 inside the neck 100. The cavity 66 is structured and configured to receive a handle engagement extension comprising a handle engagement structure 49, including a handle connector 14 (FIGS. 2-18), of any one of the plurality of mass-produced non-identical toothbrush handles. Such mass-produced non-identical toothbrush handles may include various manual toothbrush handles and various electric toothbrush handles, all of which are structured and configured for a secure removable engagement with each of the plurality of refills 10.

FIG. 1 schematically illustrates example manual toothbrush handles 12a, 12b and an example electric toothbrush handle 12c. Each of the plurality of mass-produced identical refills 10 is structured and configured to removably engage each of the plurality of mass-produced non-identical toothbrush handles 12, including handles of electric toothbrushes, which include a power source, and handles of manual toothbrushes, which are devoid of any power source.

The power source may comprise either a primary, or non-rechargeable, battery, such as, e.g., AA battery or AAA battery—or any other suitable battery known in the art. The toothbrush handle, structured and configured to contain at least one such primary battery, can be designed so that a user would be able to easily replace the battery or batteries in the handle. Alternatively, the power source can comprise a secondary battery, designed to be charged/recharged by a user via a requisite charger, i.e., a cable charger, an inductive/wireless charger, a USB charger, or any other suitable charger known in the art.

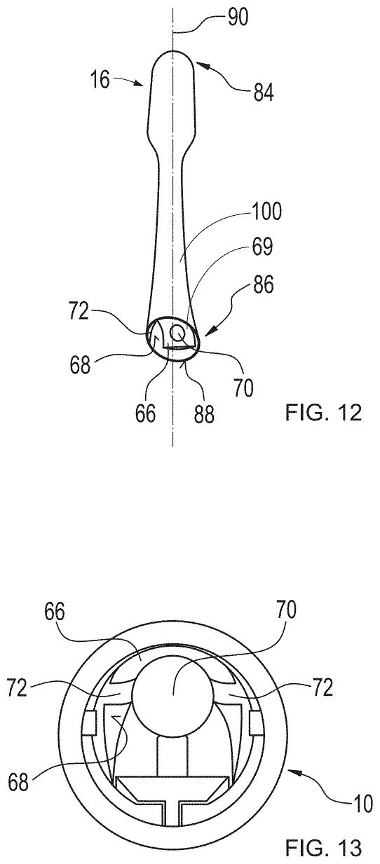

As is schematically illustrated in FIGS. 12 and 13, the neck wall 68 may include, on its inner surface, at least one rip, or groove, 72 to facilitate a precise positioning of the refill 10 when it is being connected to the handle 12 of a toothbrush. In some embodiments, it may be beneficial to provide two or more grooves 72 for a more precise positioning of the refill 10 relative to the handle 12. The wall 68, which forms the cavity 66 inside the neck 100, may include a universal refill engagement structure 69 that is structured and configured for removable engagement with the handle engagement structure 49 of each of the plurality of toothbrush handles 12, including manual toothbrush handles and electric toothbrush handles.

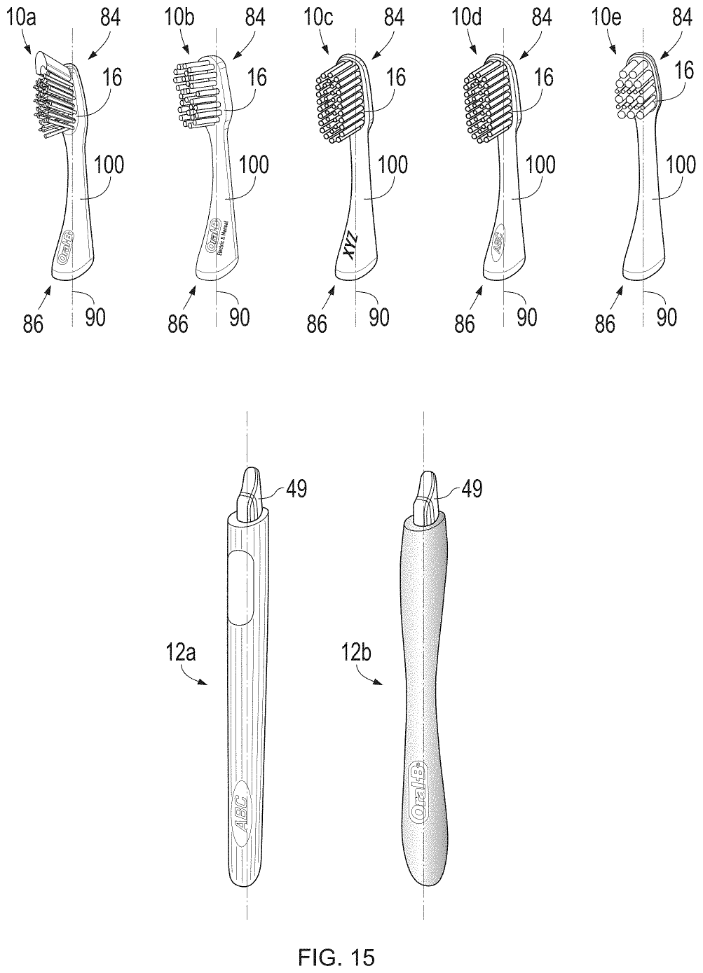

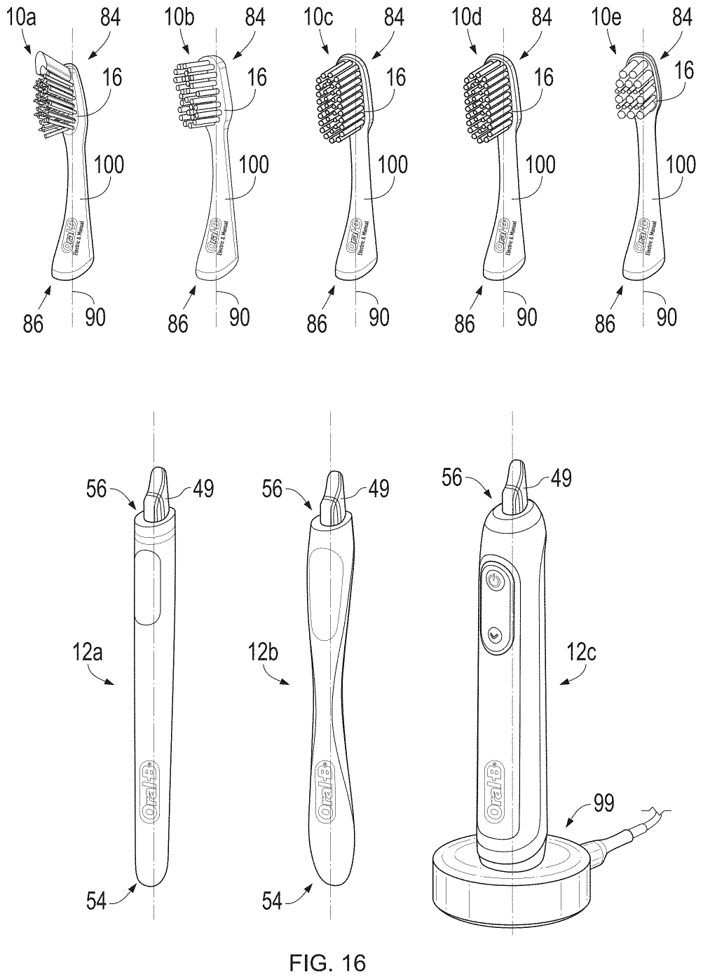

In some embodiments, one or more mass-produced refills 10, or one or more groups of the mass-produced refills 10, may include indicia indicating that the refill can be used with both compatible manual toothbrush handles and compatible electric toothbrush handles, as is schematically shown in FIG. 15 and FIG. 16. In some embodiments, the indicia may include a brand name or any other designation of the refill's origin. FIG. 15 illustrates a toothbrush system comprising a plurality of mass-produces identical refills 10 (10a, 10b, 10c, 10d, 10e . . . ) and a plurality of non-identical manual toothbrush handles, wherein the plurality of refills 10 includes refills having indicia indicating a brand name (refills 10a-10d) and indicia indicating that the refill can be used with both manual and electric toothbrush (refill 10b). In FIG. 16, each of the example refills includes indicia indicating both the brand name and the refill's quality of fitting both electric and manual (compatible) toothbrush handle.

In a further embodiment, one or more mass-produced identical refills 10, or one or more groups of the mass-produced refills 10, may be structured and configured to removably engage each of the plurality of mass-produced non-identical toothbrush handles 12a, 12b, 12c, wherein at least some of the manual toothbrush handles 12a, 12b differ from one another in at least one physical characteristic selected from the group consisting of a shape of the handle and at least one material property other than color.

In a still further embodiment, one or more mass-produced refills 10, or one or more groups of the mass-produced refills 10, may be structured and configured to removably engage each of the plurality of mass-produced non-identical toothbrush handles, wherein at least some of the manual toothbrush handles 12a, 12b differ from one another in at least one characteristic selected from the group consisting of polymer resin, color, density, surface texture, translucency, weight, magnetic qualities, and any combination thereof.

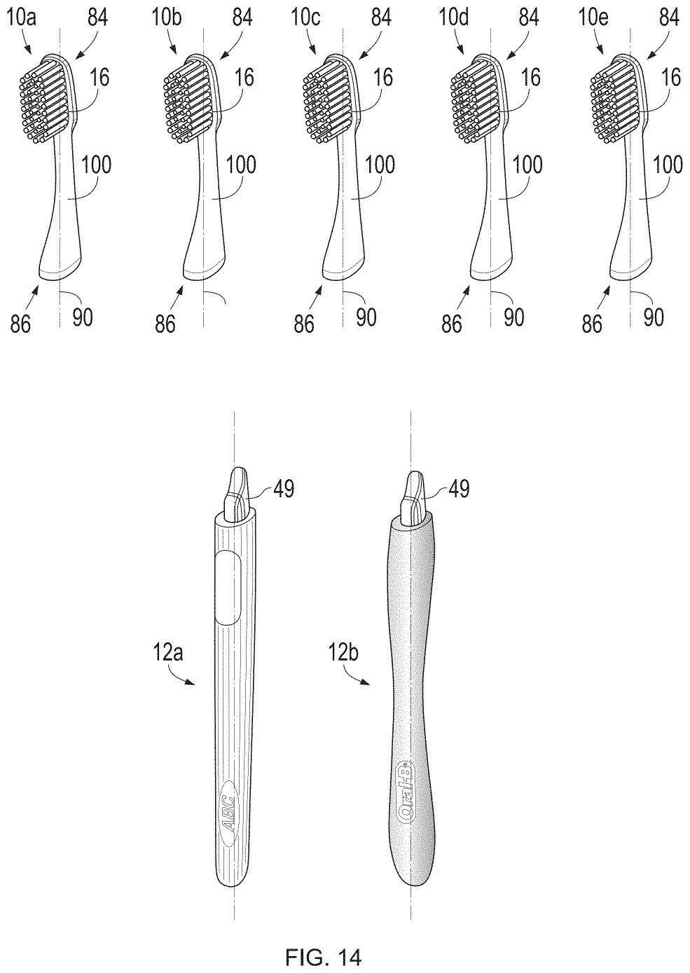

FIG. 14 illustrates a toothbrush system comprising at least a first manual toothbrush handle 12a and a second manual toothbrush handle 12b. The first manual toothbrush handle 12a comprises a first polymer, and a second manual toothbrush handle 12b comprises a second polymer different from the first polymer. The system may further include at least one toothbrush refill 10 structured and configured to be removably engageable with each of the first manual toothbrush handle 12a and the second manual toothbrush handle 12b. The first polymer may differ from the second polymer in any number of physical and aesthetic characteristics and qualities. In one example embodiment, the difference may include at least one characteristic selected from the group consisting of polymeric resin, density, surface texture, translucency, weight, magnetic qualities, and any combination thereof. In another example embodiment, those characteristics include color, e.g., various colors, various hues or variations of the same color, various combinations of colors, and the like.

FIGS. 2-13 schematically illustrate an example embodiment of a connecting structure for removable engagement between the plurality of mass-produced identical toothbrush refills 10 and the plurality of mass-produced non-identical toothbrush handles 12. As is shown in FIG. 2, the connector 14 is attached to the handle 12, and the refill 10 is attached to the connector 14. The refill 10 is structured and configured to be repeatedly attachable to and detachable from the handle 12 via connector 14. FIGS. 3-6 show, respectively, a perspective view, a side view, a front view, and a top view of the handle 12 with the connector 14 affixed thereto. The connector 14 comprises a first substantially cylindrical section 18, a second substantially cylindrical section 20, and an at least partially conically shaped section 22 connecting the first and second cylindrical sections 18, 20.

The first substantially cylindrical section 18, the at least partially conically shaped section 22, and the second substantially cylindrical sections 20 are arranged in consecutive order—and together they define a longitudinal length extension 24 of the connector 14. The longitudinal length extension 24 of the connector 14 is substantially parallel to the longitudinal axis 90 of the refill 10. The first substantially cylindrical section 18 and the second substantially cylindrical section 20 are disposed off-center with respect to the longitudinal length extension 24 of the connector 14. As is best shown in FIG. 8, the first substantially cylindrical section 18 has a first longitudinal central axis 74, and a second substantially cylindrical section 20 has a second longitudinal central axis 76. Each of the axes 74, 76 is defined as a symmetry axis of its respective section 18, 20.

The sections 18, 20 may be arranged with respect to each other so that the second longitudinal central axis 76 of the second section 20 is disposed off-center relative to the first longitudinal central axis 74 of the first section 18. This results in a distance 78 formed between the first axis 74 and the second axis 76. As is best shown in FIG. 8, when the connector 14 is seen from its side view, the central axis 76 of the second substantially cylindrical section 20 is offset from the longitudinal central axis 74 of the first substantially cylindrical section 18 by a distance 78. The distance 78 can be from 1 mm to 2.5 mm, or from 1.5 mm to 2 mm, or 1.65 mm.

The handle 12 has a distal end 54 and a proximal end 56 opposite to the distal end 54. When the refill 10 is attached to the handle 12, the proximal end 56 of the handle 12 is adjacent to the proximal end 86 of the refill 10. As is shown in FIGS. 9-11, the proximal end 56 of the handle 12 comprises a hollow portion, or recess, 58 into which a portion of the first substantially cylindrical section 18 of the c connector 14 can be inserted and fixed therein, by any number of known techniques, such as, e.g., press-fitting and/or gluing.

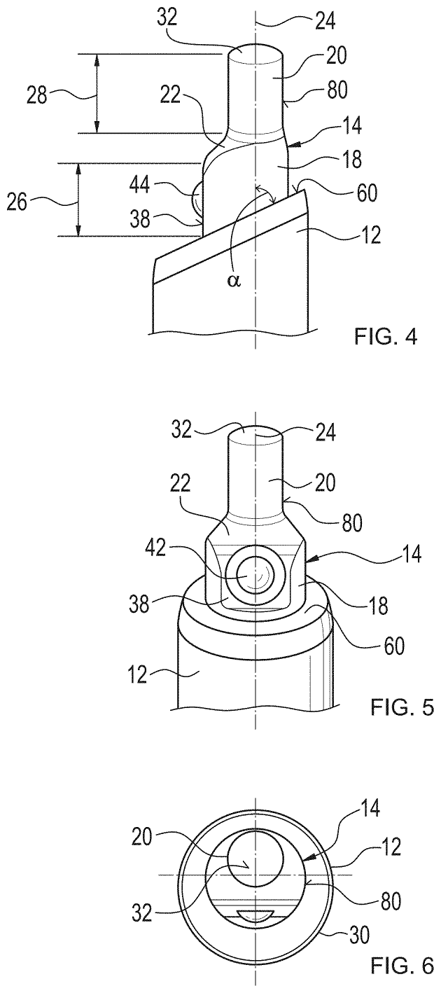

The proximal end 56 of the handle 12 comprises an end surface including a perimeter 60. The end surface/perimeter 60 can be chamfered so that it is inclined relative to the connector's longitudinal length extension 24, i.e., the end perimeter 60 is disposed in a plane that is non-perpendicular relative to the longitudinal length extension 24 of the connector 14. As is shown in FIG. 4, an angle α is formed between the plane in which the end surface 60 is disposed and the longitudinal length extension 24 of the connector 14. The angle α can be selected from the group consisting of an angle of from 30 degrees to 85 degrees, an angle from 40 degrees to 80 degrees, an angle from 50 degrees to 75 degrees, an angle from 60 degrees to 70 degrees, and an angle of 65 degrees.

Corresponding to the handle 12, the proximal end 86 of the refill 10 has an upper surface including a perimeter 88 that may be also chamfered, FIGS. 2, 12. Similarly to the angle α associated with the handle's chamfered perimeter 60, an angle formed between a plane in which the refill's chamfered surface/perimeter 88 and the refill's longitudinal axis 90 is equal to the angle α (described above)—and can be from 30 degrees to 85 degrees, from 40 degrees to 80 degrees, from 50 degrees to 75 degrees, from 60 degrees to 70 degrees, and 65 degrees.

FIGS. 3-9 schematically show several views, including perspective, side, front, and top views, of the connector 14. As is best shown in FIGS. 4 and 6, the first substantially cylindrical section 18 has a first length extension 26 and a first cross-sectional area 30, and the second substantially cylindrical section 20 has a second length extension 28 and a second cross-section 32. The first and second cross-sectional areas 30, 32 extend substantially perpendicular to the first and second length extensions 26, 28. The first cross-sectional area 30 and the second cross-sectional area 32 can be substantially circular or round. As is best shown in FIG. 6, the first cross-sectional area 30 is greater than the second cross-sectional area 32. The first cross-sectional area 30 can have a first diameter 36 of from 8 mm to 10 mm or from 8 mm to 9 mm, while the second cross-sectional area 32 can have a second diameter 34 of from 4 mm to 6 mm or from 4 mm to 5 mm.

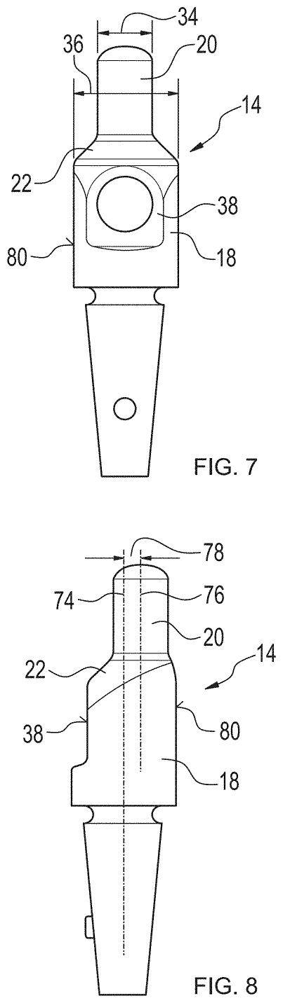

As is illustrated in FIGS. 7-8, the first substantially cylindrical section 18 may comprise a substantially flat portion 38 at the outer lateral surface 80 of the connector 14. The substantially flat portion 38 may extend along the length extension 26 of the first substantially cylindrical section 18. As is further shown in FIGS. 9-11, the substantially flat portion 38 comprises a recess 40 that forms an inner cavity 82 within a body of the connector 14. A spring-loaded ball element 42 is inserted into the cavity 82 and fixed therein. The spring-loaded ball element 42 is an element that is structured and configured to provide a snap-fit locking mechanism for sufficiently strong connection and stability between the refill 10 and the handle 12, including such connection and stability in an axial direction, i.e. along the longitudinal length extension 24 of the connector 14 and along the longitudinal axis 90 of the refill 10.

The spring-loaded ball element 42 comprises a ball 44 and a spring 46. The substantially flat portion 38 at least partially surrounds a portion of the ball 44 extending therefrom. The spring 46 applies a radial force onto the ball 44, which force is directed towards an outer surface of the substantially flat portion 38 of connector 14 (FIG. 9). The ball 44, therefore, is biased in a direction substantially perpendicular to the longitudinal length extension 24 of the connector 14. The spring 46 and the ball 44 can be arranged to be disposed in a capsule, or a cap, that can be press-fit into, and/or glued, or fixed otherwise inside, the cavity 80 of the connector 14. When the refill 10 is attached to the handle, the ball 44 extends slightly beyond the outer lateral surface of the first substantially cylindrical section 18 and arrests in a corresponding recess 70 provided inside the cavity 66 of the neck 100 of the refill 10 (FIG. 12).

A portion of the ball 44 extending outwardly above (or beyond) the surface of the substantially flat portion 38, at least partially surrounding the extending portion of the ball 44, has a height that is less than a radius of the ball 44, as measured from the surface of the substantially flat portion 38 surrounding the ball. The outwardly extending portion of the ball 44 can have a height from 20% to 50% of the ball's diameter, a height of from 25% to 45% of the ball's diameter, a height of from 30% to 40% of the ball's diameter, and a height of 35% of the ball's diameter. Both, the spring 46 and the ball 44 may be made from any suitable material, e.g., stainless steel. The ball 44 can be made from or plated/coated with, e.g., a suitable ceramic or hardened plastic material. In one embodiment, the ball's diameter is from 3 mm to 5 mm.

The first and second cylindrical sections 18, 20 of the connector 14 have a first and a second outer lateral surfaces 50, 52, respectively, FIG. 9. The first and second sections 18, 20 can be arranged with respect to each other so that a part of the first outer lateral surface 50 and a part the second outer lateral surface 52 are substantially in straight alignment along longitudinal length extension 24 of the connector 14. The substantially flat portion 38 can be arranged opposite to at least one of the first outer surface 50 and the second outer surface 52.

FIGS. 12 and 13 show, respectively, a perspective view of an embodiment of the refill 10 and its bottom view. The cavity 66, formed in the refill 10, is structured and configured for receiving the handle engagement structure 49, more specifically the connector 14, comprising the second substantially cylindrical section 20, the at least partially conically shaped section 22, and a part of the first substantially cylindrical section 18 of the connector 14, and including the spring-loaded ball element 42. The recess 70, formed on the inner side of the wall 68 is structured and configured to receive a portion of the ball 44 of the spring-loaded ball element 42 when the refill 10 is being attached to the handle 12. The wall 68 can beneficially comprise two rips, or grooves, 72 arranged, e.g., opposite to each other, for facilitating a precise adjustment and fixation of the refill 10 on the connector 14.

Either the refill 10 or the handle 12, or both, may be made from a material having magnetic and/or ferromagnetic properties. Magnetic/ferromagnetic material possesses a relatively high density—and thus a relatively heavy weight of the handle 12, which could be beneficial in terms of providing a user with a comfortable feeling during use of the toothbrush and an overall perception of a high-quality product. In one embodiment, at least one of the handle engagement structure 49 and the refill engagement structure 69 comprises a magnetic and/or ferromagnetic material. This can facilitate, though magnetic attraction, the process of connecting the refill 10 to the handle 12 and help to securely hold those together during the brushing cycle. In addition, the handle 12, either manual or electrical, comprising a magnetic and/or ferromagnetic material, could be arranged to be magnetically attached to a magnetic holder, such as, e.g., a magnetic wall holder, which would provide hygienic storage of the toothbrush—as remaining water, toothpaste slurry, and saliva would drain off from the brush while it is attached to the magnetic wall holder, thereby reducing bacteria growth on the brush. The magnetic material and/or ferromagnetic material may comprise, e.g., an amorphous thermoplastic resin, aluminum oxide, boron nitride or aluminum silicate, and iron oxide.

As used herein, the term “identical” refers to substantial structural uniformity among the plurality of refills 10 with respect to their physical shapes and dimensions particularly relevant for proper connection of the plurality of refills 10 to the plurality of toothbrush handles 12, which may include manual toothbrush handles and electric toothbrush handles. This substantial structural uniformity involves, primarily, those structural elements of the refills 10 that are designed to ensure secure removable engagement of the plurality of refills 10 with the plurality of handles 12. These structural elements comprise, e.g., the refill engagement structures 69, including the recess 70, the neck 100 and its wall 68, the upper surface 88 of the neck 100, and optionally the grooves 72.

The term “identical” does not refer to the cleaning heads 16, which may significantly differ from one another—and may comprise any suitable design, including any suitable combination of the cleaning elements, as is known in the art. In the example embodiment of FIG. 15, e.g., each of at least three of the refills 10 (10a, 10b, and 10e) comprises the cleaning head 16 that differs in design from the cleaning heads of the rest of the refills shown therein. As another example (not illustrated herein but readily recognizable by a skilled artisan), some refills 10 may include tongue-cleaning elements, such as, e.g., elastomeric tongue-cleaning elements, arranged on a backside of the cleaning head 16. Likewise, length, shape, color, surface texture, and the like of the neck 100 may differ among the plurality of refills 10, as long as the refill engagement structure 69, including the associated structural elements, instrumental for the proper connection of the refill 10 to the handle 12, remain substantially structurally identical.

Correspondingly, the plurality of handles 12, which may differ from one another in at least one of characteristic including shape, material, physical properties, or at least one function (e.g., manual vs electric), have the handle engagement structure 49 that is substantially structurally identical, or uniform, among the plurality of toothbrush handles 12.

FIG. 16 schematically illustrates an example embodiment of an oral-care kit comprising at least a first manual toothbrush handle 12a, a second manual toothbrush handle 12b, and at least one electric toothbrush handle 12c. The first manual toothbrush handle 12a differs from the second manual toothbrush handle in at least one of handle's shape, material, color, density, surface texture, translucency, weight, magnetic qualities, and any combination thereof. The kit further includes at least one electric charger 99 for charging the at least one electric toothbrush handle 12c. Although the electric handle 12a is shown in FIG. 16 in a “charging” position on the charger 99, a skilled artisan would readily understand that the charger 99 can be supplied as a separate device, not connected to the electric handle 12c. In another embodiment, the electric toothbrush handle 12c may be structures and configured to contain at least one primary, non-rechargeable, battery, easily replaceable by a user. In such an embodiment, a charger is not supplied with the kit.

The kit also includes a plurality of toothbrush refills 10, wherein each of the refills is structured and configured to be removably engageable with each of the first manual toothbrush handle 12a, the second manual toothbrush handle 12b, and the at least one electric toothbrush handle 12c, for a secure connection therewith. In an example embodiment of FIG. 16, the plurality of refills 10 includes refills (10a, 10b, 10c, and 10e) having differential cleaning heads 16, including cleaning-elements patterns that differ from one another. Likewise, a skilled artisan will appreciate that the refills 10 could have differential lengths and other physical and aesthetic attributes, as long as the refill engagement structure 69 of each of the refills 10 is structured and configured for secure removable engagement with each of the handle engagement structures 49 of the plurality of handles 12, as is previously explained.

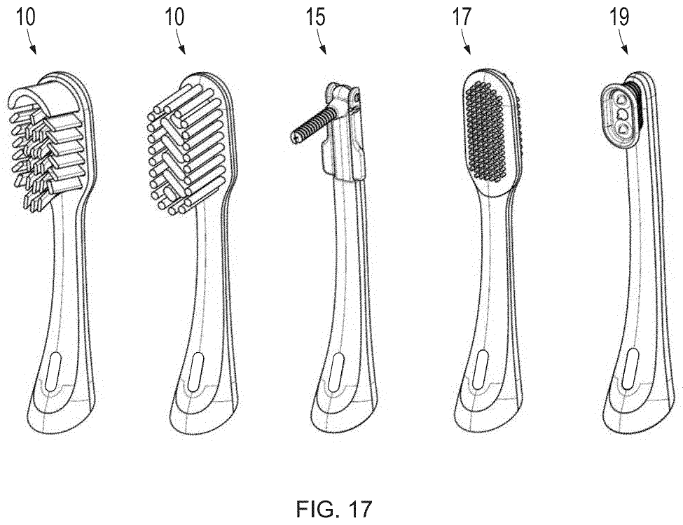

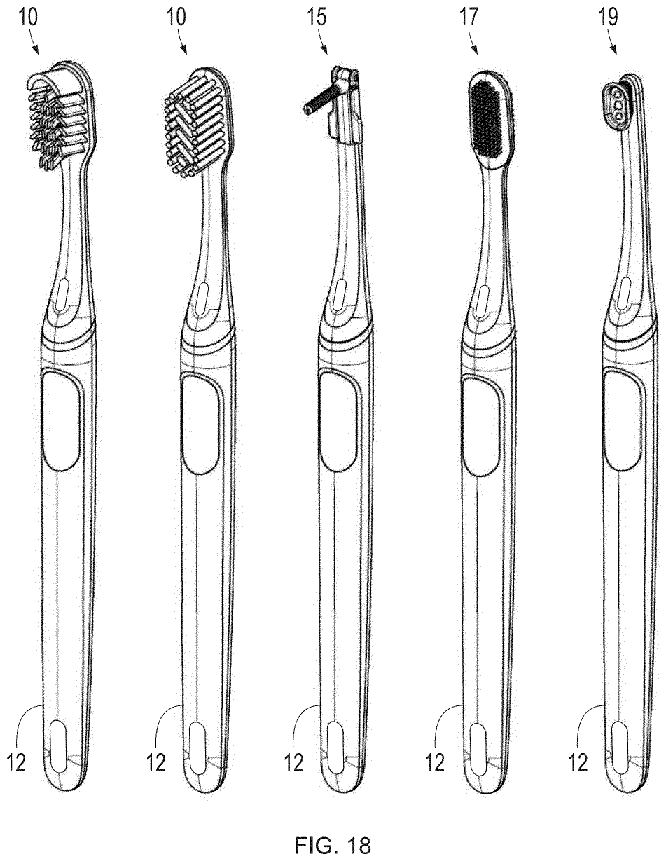

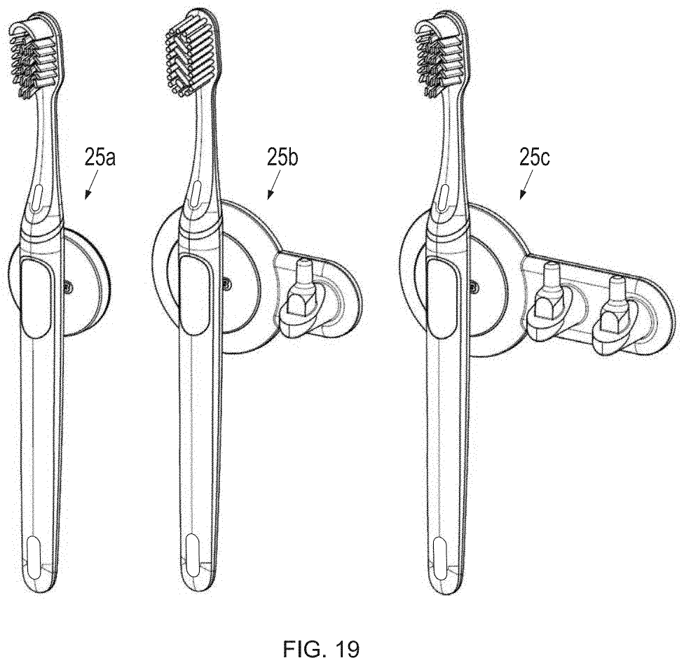

Although various embodiments of the present invention have been described in the context of an oral-care refill 10 having cleaning elements comprising tufts of bristles (or filaments), various replaceable oral-care toothbrush refills, having cleaning elements other than tufts of bristles, can be used with the toothbrush handle disclosed herein. Such refills may include, e.g., those comprising an interdental tool 15, a tongue-cleaning tool 17, and an oral-care substance applicator 19, as is illustrated in FIGS. 17, 18. FIG. 18 shows these replaceable refills (shown in FIG. 17) attached to a toothbrush handle.

The refill 10 may be made from a non-magnetic or non-ferromagnetic material, while the handle 12 may be made from a magnetic and/or ferromagnetic material. Magnetic/ferromagnetic materials possess a relatively high density—and thus a relatively heavy unit weight, which can be viewed by consumers as beneficial. In one embodiment, at least a portion of the refill 10 is at least partially made from a material having a density of from about 0.5 g/cm³ to about 1.2 g/cm³, or a density of from about 0.7 g/cm³ to about 1.0 g/cm³, or a density of about 0.9 g/cm³. For example, the refill 10 may be injection-molded from a thermoplastic polymer, e.g., polypropylene, having a density of about 0.9 g/cm³. In contrast to the head, the handle 12 can at least partially be made from a material having a significantly higher density, such as, e.g., a density of from about 2.1 g/cm³ to about 3.1 g/cm³, a density from about 2.3 g/cm³ to about 2.8 g/cm³, or a density from about 2.5 g/cm³ to about 2.7 g/cm³.

In a further embodiment, the oral-care system may include a wall holder or wall holders 25, which can be magnetic. Magnetic/ferromagnetic materials included in the handle 12 can enable the oral-care implement to be magnetically attachable to the magnetic wall holder 25, for storing the implement between uses. This would promote hygienic storage of the oral-care implement, because the remaining water, possible toothpaste slurry, and saliva would naturally drain off the brush attached to the wall holder 25. That would also facilitate quick drying of the brush—and would consequently inhibit bacteria growth thereon.

The magnetic wall holder 25 may have a shape of a disk, or have any suitable shape, and should preferably be configured for an easy cleaning. The wall holder 25 can be designed to be attachable to a wall by any known technique, e.g., adhesion, vacuum suction, and/or by means of additional armature (such as, e.g., brackets and/or screws). A user needs merely to bring the oral-care implement in close proximity to the magnetic wall holder, so that the oral-care implement gets attached to the holder 25 magnetically, wherein no precise positioning is required. As the magnetic properties can be beneficially provided in the handle 12, but not in the refill 10, the refill 10 would not get attached to the magnetic holder 25, which would reduce the undesirable possibility of the magnetic holder 25 becoming soiled.

FIG. 19 illustrates embodiments of the magnetic wall holder. A first embodiment of the magnetic wall holder 25a is structured and configured to hold a single oral-care handle, which can have a refill attached thereto. A second embodiment of the magnetic wall holder 25b is structured to hold a single oral-care handle and one additional refill, which can be placed on the specially designed projection configured to receive the refill's opening. The third embodiment of the magnetic wall holder 25c is structured to hold an oral-care handle and two additional refills.

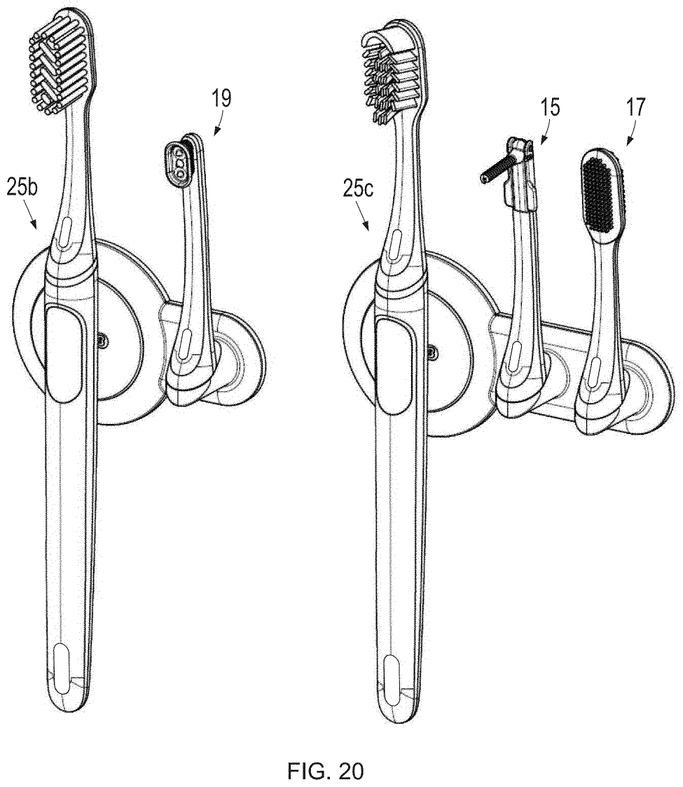

FIG. 20 illustrates the magnetic wall holders 25b and 25c having additional refills storage thereon. The wall holder 25b is shown with a toothbrush and an additional chemical-substance applicator 19. The wall holder 25c is shown with a toothbrush and an additional interdental tool 15 and an additional tongue-cleaning tool 17.

In one embodiment, the magnetic and/or ferromagnetic material forming at least a part of the handle 12 may comprise an amorphous thermoplastic resin. The magnetic and/or ferromagnetic material may further comprise aluminum oxide, boron nitride or aluminum silicate. Furthermore, the magnetic and/or ferromagnetic material may comprise in addition or alternatively iron oxide. The magnetic and/or ferromagnetic material may further comprise glass fibers which may be pre-mixed with at least a portion of the amorphous thermoplastic resin. Such handle material allows for control of the weight of the handle in whatever location, e.g. by filler variation.

In one embodiment, the magnetic and/or ferromagnetic material may comprise, e.g., from about 13 weight percent to about 30 weight percent of an amorphous thermoplastic resin; from about 3 weight percent to about 25 weight percent of aluminum oxide, boron nitride or aluminum silicate; and from about 45 weight percent to about 67 weight percent of iron oxide. Such composition provides a material density that is about three times the density of a common plastic material used for toothbrushes, e.g., polypropylene. With higher weight and higher thermal conductivity, the material drives value perception, in particular in combination with a galvanic coating. Such coating may be made from real metal. The galvanic coating can be applied in a selective electroplating process. During this coating process for a multicomponent plastic part, a metallic layer is only deposited on a hard material while a further over molded soft component may remain unaffected.

The magnetic and/or ferromagnetic material may comprise about 27.5 weight percent of an amorphous thermoplastic resin, about 17 weight percent of aluminum oxide, about 51 weight percent of iron oxide, and about 4.5% glass fiber. The amorphous thermoplastic resin may comprise a styrene resin, e.g. styrene acrylonitrile “SAN”. The amorphous thermoplastic resin may be selected from the list consisting of acrylonitrile butadiene styrene, polystyrene, and styrene acrylonitrile. The amorphous thermoplastic resin may comprise about 17% weight percent styrene acrylonitrile, and 10.5 weight percent of a mixture comprising polybutylene terephthalate and polyethylene terephthalate.

As one skilled in the art would recognize, the term “substantially” refers herein to an arrangement of elements or features that, while in theory would be expected to exhibit the exact correspondence or behavior, may in practice embody something slightly less than exact. As such, the term denotes the degree by which a quantitative value, measurement or other related representation may vary from a stated reference without resulting in a change in the basic function of the subject matter at issue. Thus, the term “substantially” in conjunction with the term “identical” (as in “substantially identical”) means that minor variation from absolute identity could be tolerated as long as these minor variations are inconsequential for the purpose of achieving a secure detachable/removable connection between the refills 10 and the handles 12, i.e., as long as these minor variation do not compromise the quality of said connection.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “10 mm” is intended to mean “about 10 mm”; an angle disclosed as being “from 40 degrees to 80 degrees” is intended to mean an angle “from about 40 degrees to about 80 degrees,” and a percentage disclosed as “35%” is intended to mean “about 35%.”

A disclosure of every document cited herein, including any cross-referenced or related patent or application and any patent application or patent to which this application claims priority or benefit thereof, is hereby incorporated herein by reference in its entirety, unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and the scope of the invention. It is therefore intended to cover in the appended claims all such changes and modifications that are within the scope of this invention.

1. A plurality of mass-produced identical toothbrush refills for a secure removable engagement with a plurality of mass-produced non-identical toothbrush handles, each of the plurality of mass-produced identical refills comprising:
a proximal end and a distal end opposite thereto and a longitudinal axis extending between the proximal end and the distal end;
a cleaning head disposed adjacent to the distal end and comprising a plurality of cleaning elements;
a neck extending from the cleaning head and terminating at the proximal end, the neck comprising a wall defining a cavity configured to receive a handle engagement structure of any one of the plurality of mass-produced non-identical toothbrush handles for the secure removable engagement therewith;
wherein each of the plurality of mass-produced identical refills includes a refill engagement structure configured to form the secure removable engagement with the handle engagement structure; and
wherein each of the plurality of mass-produced identical refills is structured and configured to removably engage each of the plurality of mass-produced non-identical toothbrush handles including handles of electric toothbrushes, which include a power source, and handles of manual toothbrushes, which do not include a power source.

2. The plurality of mass-produced identical toothbrush refills of claim 1, wherein the refill engagement structure comprises at least one recess disposed in the wall of the neck and configured to receive at least a portion of the handle engagement structure, wherein the at least one recess is configured to receive the at least a portion of the handle engagement structure comprising a spring-loaded ball comprising the at least a portion of the handle engagement structure.

3. The plurality of mass-produced identical toothbrush refills of claim 2, wherein the refill engagement structure comprises a groove disposed on an interior surface of the wall of the neck and configured to facilitate the secure removable engagement between the refill and the toothbrush handle.

4. The plurality of mass-produced identical toothbrush refills of claim 1, wherein the proximal end of the neck comprises an end perimeter disposed in a plane that is non-perpendicular relative to the longitudinal axis of the refill.

5. The plurality of mass-produced identical toothbrush refills of claim 1, wherein each of the refills includes indicia indicating that the refill can be used with a compatible manual toothbrush handle and a compatible electric toothbrush handle.

6. The plurality of mass-produced identical toothbrush refills of claim 1, wherein each of the plurality of mass-produced identical refills is structured and configured to removably engage each of the plurality of mass-produced non-identical toothbrush handles including handles of electric toothbrushes, which include a power source, and handles of manual toothbrushes, which do not include a power source, wherein at least some of the handles of electric toothbrushes comprises handles of electric toothbrushes structured and configured to contain therein a battery.

7. The plurality of mass-produced identical toothbrush refills of claim 1, wherein the refill engagement structure comprises a magnetic or ferromagnetic material.

8. A versatile toothbrush refill having a proximal end, a distal end opposite to the proximal end, and a longitudinal axis extending between the proximal and distal ends, the refill comprising:
a head adjacent to the distal end and including cleaning elements;
a neck extending from the head along the longitudinal axis and terminating at the proximal end, the neck comprising a wall defining a cavity configured to receive therein a handle engagement extension comprising a handle engagement structure;
wherein the wall comprises a refill engagement structure for engaging the handle engagement structure; and
wherein the refill engagement structure is configured for a removable engagement with each of a first handle engagement structure of a first manual toothbrush handle and a second handle engagement structure of a second manual toothbrush handle, wherein the first manual toothbrush handle differs from the second manual toothbrush handle in at least one physical characteristic selected from the group consisting of a shape of the handle and at least one material property other than color.

9. The refill of claim 8, wherein the refill engagement structure comprises:
at least one recess disposed in the wall of the neck and configured to receive at least a portion of the handle engagement structure, wherein the at least one recess is configured to receive the at least a portion of the handle engagement structure comprising a spring-loaded ball biased against the handle engagement extension; and
a groove disposed on an interior surface of the wall of the neck and configured to facilitate the secure removable engagement between the refill and each of the first manual toothbrush handle and the second manual toothbrush handle.

10. The refill of claim 8, wherein the proximal end of the neck comprises an end perimeter disposed in a plane that is non-perpendicular relative to the longitudinal axis of the refill, wherein an angle formed between the plane in which the end perimeter is disposed and the longitudinal axis of the refill is selected from the group consisting of an angle of from 30 degrees to 85 degrees, an angle from 40 degrees to 80 degrees, an angle from 50 degrees to 75 degrees, an angle from 60 degrees to 70 degrees, and an angle of 65 degrees.

11. The refill of claim 8, wherein the refill includes indicia comprising a brand name, wherein the brand name of the refill differs from at least one of a brand name of the first manual toothbrush handle and a brand name of the second manual toothbrush handle.

12. An oral-care kit, comprising:
at least a first manual toothbrush handle and a second manual toothbrush handle, wherein the first manual toothbrush handle differs from the second manual toothbrush handle in at least one characteristics selected from the group consisting of shape, color, density, surface texture, translucency, weight, magnetic qualities, and any combination thereof;
at least one electric toothbrush handle; and
a plurality of versatile toothbrush refills, wherein each of the plurality of refills is structured and configured to be removably engageable with each of the first manual toothbrush handle, the second manual toothbrush handle, and the electric toothbrush handle.

13. The oral-care kit of claim 12, wherein each of the plurality of refills comprises:
a proximal end and a distal end opposite thereto and a longitudinal axis extending between the proximal end and the distal end;
a cleaning head disposed adjacent to the distal end and comprising a plurality of cleaning elements;
a neck extending from the cleaning head and terminating at the proximal end, the neck comprising a wall defining a cavity configured to receive, for a secure removable engagement therewith, each of a handle engagement structure of the at least first manual toothbrush handle, a handle engagement structure of the at least second manual toothbrush handle, and a handle engagement structure of the at least one electric toothbrush handle.

14. The oral-care kit of claim 12, wherein each of the plurality of refills includes a refill engagement structure comprising a spring-loaded element including a ball biased in a direction substantially perpendicular the longitudinal axis of the refill, wherein the refill engagement structure comprises a groove disposed on an interior surface of the wall of the neck and configured to facilitate the secure removable engagement between the refill and each of the at least first manual toothbrush handle, the at least second manual toothbrush handle, and the at least one electric toothbrush handle.

15. The oral-care kit of claim 12, wherein the kit further comprises at least one electric charger for charging the at least one electric toothbrush handle.

16. The oral-care kit of claim 12, wherein each of the plurality of refills is at least partially made from a material having a density from about 0.5 g/cm³ to about 1.2 g/cm³, and each of the at least first and second manual toothbrush handles and the at least one electric toothbrush handle is at least partially made from a material having a density from about 2.1 g/cm³ to about 3.1 g/cm³.

17. An oral-care refill having a proximal end, a distal end opposite to the proximal end, and a longitudinal axis extending between the proximal and distal ends, the refill comprising:
a head adjacent to the distal end and including cleaning elements;
a neck extending from the head along the longitudinal axis and terminating at the proximal end, the neck comprising a wall defining a cavity configured to receive therein a handle engagement extension, the handle engagement extension comprising a handle engagement structure;
wherein the wall comprises a refill engagement structure for engaging the handle engagement structure; and
wherein the refill engagement structure is configured to be compatible for a secure removable engagement with each of a first toothbrush handle that includes a power source and a second toothbrush handle that does not include a power source.

18. The refill of claim 17, wherein the refill engagement structure comprises at least one recess disposed in the wall of the neck and configured to receive at least a portion of the handle engagement structure comprising a spring-loaded ball biased in a direction substantially perpendicular to the longitudinal axis of the refill, wherein the refill engagement structure comprises a groove disposed on an interior surface of the wall of the neck and configured to facilitate the secure removable engagement between the refill and the toothbrush handle.

19. The refill of claim 17, wherein the proximal end of the neck comprises an end perimeter disposed in a plane that is non-perpendicular relative to the longitudinal axis of the refill, wherein an angle formed between the plane in which the end perimeter is disposed and the longitudinal axis of the refill is selected from the group consisting of an angle of from 30 degrees to 85 degrees, an angle from 40 degrees to 80 degrees, an angle from 50 degrees to 75 degrees, an angle from 60 degrees to 70 degrees, and an angle of 65 degrees.

20. The refill of claim 17, wherein the refill is structured and configured to removably engage each of the first toothbrush handle and the second toothbrush handle, wherein the first toothbrush handle is structured and configured to contain therein a battery.
